(19) United States
(12) Patent Application Publication
(10) Pub. No.: US 2026/0225806 A1
(43) Pub. Date: Aug. 6, 2026

(54) Docking Accessory for Mobile Robots

(71) Applicant: Zebra Technologies Corporation, Lincolnshire, IL (US)

(72) Inventors: Cory D. Lent, Campbell, CA (US); Charles Pitzer, San Jose, CA (US); Vincent C. Cheung, San Jose, CA (US); Aaron Hoy, San Jose, CA (US); Harry W. Winand, Corralitos, CA (US); Mark David Medonis, Saint Augustine, FL (US)

(73) Assignee: Zebra Technologies Corporation, Lincolnshire, IL (US)

(21) Appl. No.: 19/195,464

(22) Filed: Apr. 30, 2025

Related U.S. Application Data
(60) Provisional application No. 63/752,632, filed on Jan. 31, 2025.

(51) Int. Cl. B65G 1/137

(52) U.S. Cl. CPC B65G 1/137

(57) ABSTRACT

A mobile robot includes: a chassis; a locomotive assembly secured to the chassis; a coupling device disposed on the chassis, the coupling device comprising a base with first and second pins configured to extend from the base and engage with a target object; and a processor configured to: control the locomotive assembly to position the coupling device relative to the target object; select between (i) an intermediate state, and (ii) a docked state; in response to selecting the intermediate state, control the coupling device to permit rotation of the chassis relative to the target object, and constrain translation of the chassis relative to the target object; and in response to selecting the docked state, control the coupling device to constrain rotation and translation of the chassis relative to the target object.

### CROSS-REFERENCE TO RELATED APPLICATIONS

This application claims priority from provisional patent application no. 63/752632, filed Jan. 31, 2025, the entire contents of which is incorporated herein by reference.

### BACKGROUND

Autonomous mobile robots (“AMRs”) utilized in fulfillment and material movement applications may be provided with systems for interfacing with support structures for transporting items, such as for example, carts, shelves, and the like. For example, these systems can comprise an accessory mounted on a top surface of the AMR that can selectively engage and disengage a receiving plate affixed to a bottom surface of a cart or other support structure. These systems can rigidly couple the AMR to the cart, which can present disadvantages.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of item-handling mobile robots deployed in a facility.

FIG. 2A is a diagram of a mobile robot of FIG. 1.

FIG. 2B is a diagram of certain internal components of the mobile robot of FIG. 2A.

FIG. 3 is a diagram of a cart from the system of FIG. 1, viewed from below.

FIG. 4A is a plan view of a receiving plate of the cart of FIG. 3.

FIG. 4B is a diagram illustrating another example receiving plate.

FIG. 5 is a diagram illustrating a docking accessory on the mobile robot of FIG. 2A.

FIG. 6 is a diagram the docking accessory and mobile robot of FIG. 5, with the docking accessory shown in cross section.

FIG. 7 is a cross-sectional view of the docking accessory of FIG. 6 in isolation.

FIG. 8A is a side view of the docking accessory of FIG. 5 in an undocked state.

FIG. 8B is a side view of the docking accessory of FIG. 5 in an intermediate state.

FIG. 8C is a side view of the docking accessory of FIG. 5 in a docked state.

FIG. 9 is a flowchart of a method of engaging with a target object.

FIGS. 10A, 10B, and 10C are diagrams illustrating successive re-orientations of a cart relative to a mobile robot with another example docking accessory.

FIGS. 11A and 11B are diagrams illustrating another re-orientation of a cart relative to a mobile robot with the docking accessory of FIGS. 10A-10C.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a mobile robot, comprising: a chassis; a locomotive assembly secured to the chassis; a coupling device disposed on the chassis, the coupling device comprising a base with first and second pins configured to extend from the base and engage with a target object; and a processor configured to: control the locomotive assembly to position the coupling device relative to the target object; select between (i) an intermediate state, and (ii) a docked state; in response to selecting the intermediate state, control the coupling device to permit rotation of the chassis relative to the target object, and constrain translation of the chassis relative to the target object; and in response to selecting the docked state, control the coupling device to constrain rotation and translation of the chassis relative to the target object.

Additional examples disclosed herein are directed to an interface system for an autonomous mobile robot, comprising: an index plate configured to be mounted on a mobile robot, the index plate having a center pin and one or more index pins extending from a top surface thereof; a receiving plate configured to be mounted to a support structure, the receiving plate having a center aperture configured to receive the center pin, and a plurality of auxiliary apertures holes configured to receive the one or more index pins; wherein the index plate is positionable in: (i) a first state in which the center pin is received by the center aperture, and the one or more index pins are received by respective ones of the auxiliary apertures, thereby constraining rotational movement between the index plate and the receiving plate; and (ii) a second position in which the center pin is received by the center aperture and the one or more index pins are not received by the auxiliary apertures, thereby allowing rotational movement between the index plate and the receiving plate.

Further examples disclosed herein are directed to a docking accessory for a mobile robot, the docking accessory comprising: a coupling device configured for support by a chassis of the mobile robot, the coupling device configured to engage with a target object and movable between (i) a docked state to constrain rotation and translation of the chassis relative to the target object, and (ii) an intermediate state to permit rotation of the chassis relative to the target object, and constrain translation of the chassis relative to the target object; and a communications interface to communicatively connect the coupling device with a processor and receive control instructions therefrom.

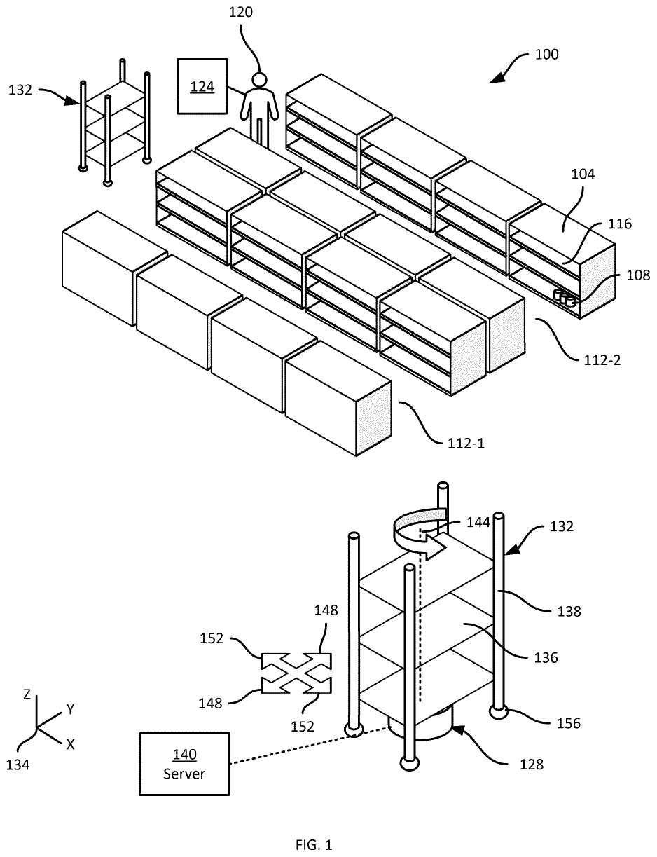

FIG. 1 illustrates an interior of a facility 100, such as a warehouse, a manufacturing facility, a healthcare facility, or the like. The facility 100 includes a plurality of support structures 104 carrying items 108. In the illustrated example, the support structures 104 include shelf modules, e.g., arranged in sets forming aisles 112-1 and 112-2 (collectively referred to as the aisles 112, and generically referred to as an aisle 112; similar nomenclature may be used herein for other components with hyphenated reference numbers). In the examples shown in FIG. 1, the support structures 104 include support surfaces 116 supporting the items 108. The support structures 104 can also include pegboards, bins, tables, or the like, in other examples. In some examples, the support structures 104 can include portions of a floor of the facility 100, in addition to or instead of distinct structures disposed on the floor, such as the shelf modules shown in FIG. 1.

In other examples, the facility 100 can include fewer aisles 112 than shown, or more aisles 112 than shown in FIG. 1. The aisles 112, in the illustrated example, are formed by sets of support structures 104 (four on each side, although it will be understood that the aisles 112 may have a variety of lengths defined by varying numbers of support structures 104). The facility 100 can also have a wide variety of other aisle layouts, however. As will be apparent, each aisle 112 is a space open at opposing ends, and bounded on either side by one or more support structures 104. The aisles 112 can be travelled by humans, certain vehicles, and the like. In still further examples, the facility 100 need not include aisles 112, and can instead include assembly lines, or the like.

The items 108 may be handled according to a wide variety of processes, depending on the nature of the facility. In the examples discussed below, the facility 100 is a fulfillment facility or the like, and the items 108 disposed on the support structures 104 can be retrieved for shipping from the facility 100 to fulfill incoming orders, each order including identifiers of certain items. The retrieval of an item 108 from a support structure 104 is also referred to as a pick operation. Picks can be performed in the facility 100 by a picker 120, such as a human worker. Although one picker 120 is shown in FIG. 1, it will be understood that various numbers of pickers can be deployed in the facility 100, e.g., depending on the size of the facility 100, the rate at which orders are received for fulfillment, and the like. Each picker 120 can operate a client computing device 124, such as a tablet computer, a smartphone, a wearable computer, or the like. The client device 124 enables the presentation of information to the picker 120, the capture of information from the picker 120, e.g., indicating completion of a pick task, or the like.

Order fulfillment in the facility 100 can be assisted by mobile robots, of which an example robot 128 is shown in FIG. 1. Additional robots 128 can be deployed in the facility 100, for example based on the size and/or layout of the facility 100. As will be discussed below, the facility 100 may contain a greater number of robots 128 than pickers 120 in some embodiments. In other embodiments, a number of robots 128 deployed in the facility 100 may be smaller than a number of pickers 120 in the facility 100.

To perform an order fulfillment task, or a portion thereof, the picker 120 can retrieve one or more items 108 from a support structure 104, and place the items 108 on a movable support, such as a wheeled cart 132 having one or more shelves or other support surfaces 136 supported by legs 138. Two example carts 132 are shown in FIG. 1, but it will be understood that the number of carts 132 deployed in the facility 100 may vary according to the size of the facility and/or other operational considerations. Further, the number of carts 132 deployed in the facility 100 need not match either of the number of robots 128, or the number of pickers 120.

The items 108 involved in fulfilling an order may be on support structures 104 at various locations in the facility 100. A given cart 132 may be moved about the facility 100 to collect the relevant items 108 for the order, e.g., before being moved to a pack-out area or the like. Moving of the cart 132 to various locations in the facility 100 can be performed by the robot 128. The robot 128 can navigate through the facility 100 while tracking its pose (e.g., location and orientation) relative to a coordinate system 134 previously established in the facility 100. The robot 128 can dock with a cart 132 and therefore move the cart 132 about the facility 100 during such navigation. The robot 128 can receive target locations to navigate to, e.g., to collect a cart 132, and to move that cart 132 to a sequence of pick locations to receive items 108 from the support structures 104 (e.g., placed on the cart 132 by the picker 120). The target locations, and/or other control data, can be received at the robot 128 from a server 140 or other suitable computing device via one or more communication networks deployed within the facility 100. In other examples, the robot 128 can also be configured to dock with a target object other than a cart 132. For example, the robot 128 can be configured to transport equipment between locations in the facility 100 by docking with the equipment and navigating to such locations, towing the docked equipment.

When the robot 128 approaches a cart 132, the robot 128 can initiate a docking procedure that involves positioning the robot in a predetermined pose relative to the cart 132 (e.g., dependent on the direction in which the robot 128 is intended to move the cart 132), and activating a docking accessory, also referred to herein as an interface accessory, to mechanically couple the robot 128 to the cart 132. Mitigating unexpected movements of the cart 132 during transit involves limiting, or substantially eliminating, at least translational movement of the cart 132 relative to the robot 128 when docked. Translational movement is movement in the XY plane of the coordinate system 134 as shown in FIG. 1. In some examples, the docking accessory is also configured to limit, or eliminate, uncontrolled rotational movement, e.g., relative rotation between the robot 128 and the cart 132, about an axis 144.

The docking accessory may therefore have tight tolerances, and the robot 128 may be required to position itself relative to the cart 132 with a high degree of accuracy. Errors in localization by the robot 128 may lead to a failed docking attempt, followed by an attempt to correct the position of the robot 128 relative to the cart 132 and a repeated attempt to dock with the cart 132. Each such attempt consumes time, reducing the availability of the robot 128 and the cart 132 for order fulfillment or other suitable tasks. The present disclosure provides mobile robot docking accessories and associated receiving plates coupled to the carts, which cooperate to reduce, or eliminate, failed docking attempts due to errors in localization, or other errors related to the docking process.

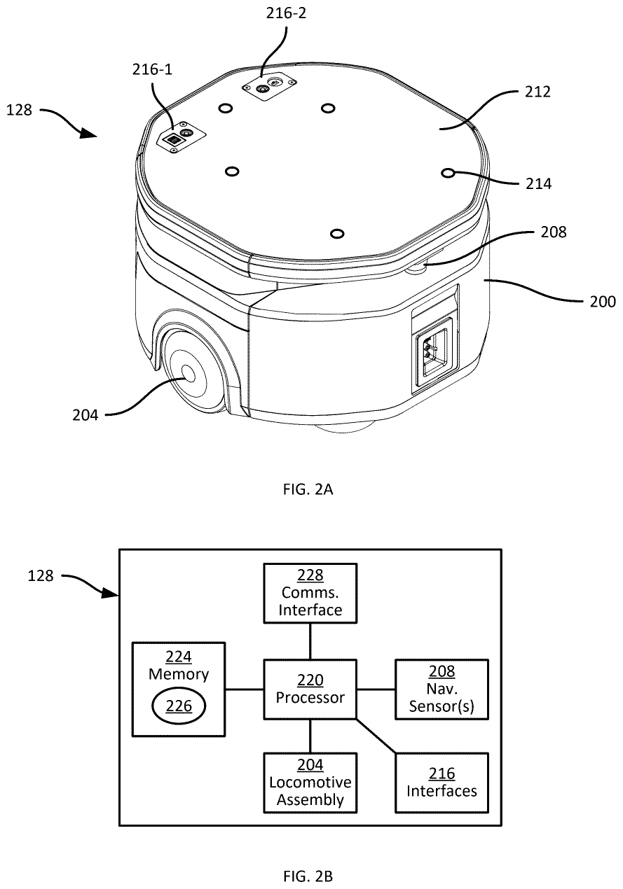

In some examples, the robot 128 can be configured to dock with the cart 132 at more than one predetermined pose relative to the cart 132. For example, some use cases may involve moving the cart 132 forwards or backwards, e.g., in the direction as indicated by the arrows 148 in FIG. 1. Forward or backward motion, in other words, aligns with the longer sides of the cart 132. Other use cases may involve moving the cart orthogonally, e.g., in the directions indicated by the arrows 152. The robot 128, as discussed below in connection with FIGS. 2A and 2B, includes navigational sensors with fields of view extending in a given direction from the robot 128. To keep the navigational sensors facing in the direction of travel of the robot 128, the robot 128 may therefore be configured to re-orient itself relative to the cart 132 when switching between moving the cart 132 longitudinally and orthogonally.

A previous approach to re-orienting the mobile robot 128 includes, for example, turning the robot 128 in place while (e.g., rigidly) docked with the cart 132. This approach has the advantage of maintaining a mechanical connection between the robot 128 and the cart 132, but the disadvantage or requiring the application of a potentially significant amount of torque by the drive assembly of the robot 128, to overcome the weight of the cart 132 and or to flip casters 156 of the cart 132. Rotating the cart 132 may also involve increased navigational complexity, as the robot 128 may be required to track the physical boundaries of the cart 132 as it rotates.

Another previous approach to re-orienting the robot 128 includes undocking from the cart 132, re-orienting the robot 128, and re-docking with the cart 132. This approach avoids the complexity of tracking the position of a rotating cart 132, as noted above, because the cart 132 is not coupled to the robot 128 during re-orientation of the robot 128 (e.g., relative to the cart 132). This approach also avoids the need for significant application of torque to the drive assembly of the robot 128 to rotate the cart 132. However, introducing additional docking attempts increases the likelihood of failed docking attempts. Furthermore, when the robot 128 undocks from the cart 132 and rotates, e.g., about the axis 144, the casters 156 may settle, causing a translation of the cart 132 relative to the robot 128. In other examples, an uneven floor may cause the cart 132 to translate relative to the robot 128. In either case, an attempt to re-dock with the cart 132 may fail if the cart has moved from its last location known to the robot 18. The above conditions may be referred to as cart “runaway,” in which the cart 132 shifts unpredictably during a period the cart 132 was expected to remain stationary.

As described below, docking accessories are provided that reduce the likelihood of failed docking attempts. Some docking accessories discussed below also reduce or eliminate the mechanical strain on the drive assembly of the robot 128 associated with rotating a potentially heavy cart 132. The docking assemblies discussed herein provide an intermediate docking state that permits reorientation of the robot 128 relative to the cart 132 without fully disengaging from the cart 132. The intermediate state permits rotation of a chassis of the robot 128 relative to the cart 132 and constrains translation of the robot 128 relative to the cart 132. The intermediate state may thereby facilitate changes in orientation between the robot 128 and the cart 132 while mitigating or avoiding docking failures that might result from fully disengaging the robot 128 from the cart 132 to re-orient the robot 128 relative to the cart 132.

Before discussing the above-mentioned docking accessories in greater detail, certain components of the robot 128 are discussed with reference to FIGS. 2A and 2B. As shown in FIG. 2A, the robot 128 includes a chassis 200 supporting various other components of the robot 128. In particular, the chassis 200 supports a locomotive assembly 204, such as one or more electric motors, e.g., powered by an onboard battery or other suitable power source, driving a set of wheels, tracks, or the like. The locomotive assembly 204 can include one or more sensors such as a wheel odometer, an inertial measurement unit (IMU), and the like. The chassis 200 also supports one or more navigational sensors 208, such as one or more cameras and/or depth sensors (e.g., lidars, depth cameras, time-of-flight cameras, or the like). The sensor(s) 208 can be configured to capture image and/or depth data depicting at least a portion of the physical environment of the robot 128. Data captured by the sensor(s) 208 can by used by processing hardware of the robot 128 for navigational purposes, e.g., path planning, obstacle avoidance, and the like.

The chassis 200 can also define a mounting surface 212, e.g., on an upper wall of the chassis 200, for removably receiving one or more accessories. The mounting surface 212 can removably receive a docking accessory, as described below. The docking accessory can be affixed to the chassis 200 via fasteners such as bolts or the like, removably received in openings 214 on the mounting surface 212. The mounting surface 212 can also include one or more interface assemblies 216-1 and 216-2. The assembly 216-1 includes, in this example, a communications interface such as a Universal Serial Bus (USB) port, and a power delivery port. The assembly 216-2 includes, in this example, a communications interface such as an Ethernet port (e.g., an RJ-45 port), and a further power delivery port. A variety of other interface assembly configurations can also be implemented, e.g., incorporating two or more communications interfaces in one assembly 216 rather than divided between the assemblies 216-1, 216-2 as shown in FIG. 2A.

FIG. 2B is a block diagram of certain components of the robot 128, including certain internal components not shown in FIG. 2A. In particular, the robot 128 includes a processor 220, e.g., one or more central processing units (CPUs), graphics processing units (GPUs), or dedicated hardware controllers such as application-specific integrated circuits (ASICs). The processor 220 is communicatively coupled with a non-transitory computer readable medium such as a memory 224, e.g., a suitable combination of volatile and non-volatile memory elements. The memory 224 stores various data used for autonomous or semi-autonomous navigation, including computer-readable instructions executable by the processor 220 to implement navigational and other task execution functions. The memory 224 can store, for example, computer-readable instructions defining a navigational application 226 whose execution by the processor 220 configures the robot 128 to implement docking functionality via control of the docking accessories described herein.

The processor 220 is also coupled to a communications interface 228, such as a wireless transceiver enabling the robot 128 to communicate with other computing devices, such as the server 140, client device 124, and other robots 128. The processor 220 can also be communicatively coupled to the interface assemblies 216 mentioned above, e.g., to control accessories such as a docking accessory affixed to the chassis 200, and in some implementations, to receive sensor data from such accessories.

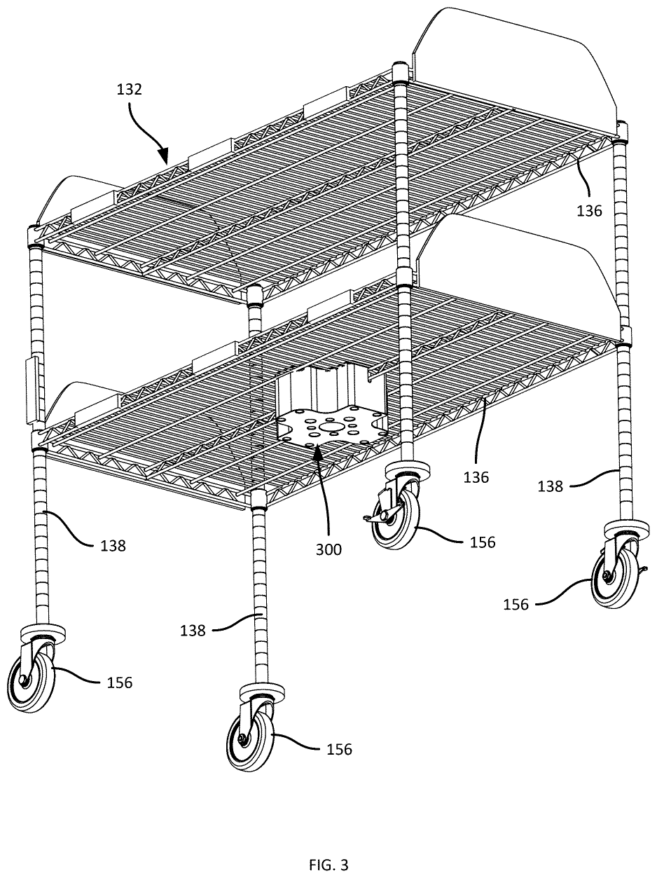

Referring to FIG. 3, an example cart 132 is shown, with two support surfaces 136 supported by four legs 138 each terminating with casters 156 or other suitable wheels. As will be apparent, the carts 132 can have varying configurations of support surfaces 136 (e.g., other numbers of support surfaces, bins instead of or in addition to shelves, and the like). The lower support surface 136, closer to the casters 156, includes a receiving plate 300 affixed to the bottom thereof. The receiving plate 300, in other words, is coupled to the cart 132 so as to be exposed towards the floor on which the cart 132 rests. The receiving plate 300 is a component of an interface system for the robot 128 to dock with, and manipulate, the cart 132. The receiving plate 300 can be affixed to the support surface 136, for example, by way of a retaining plate above the support surface 136, fastened to the receiving plate 300 by bolts or other suitable fasteners.

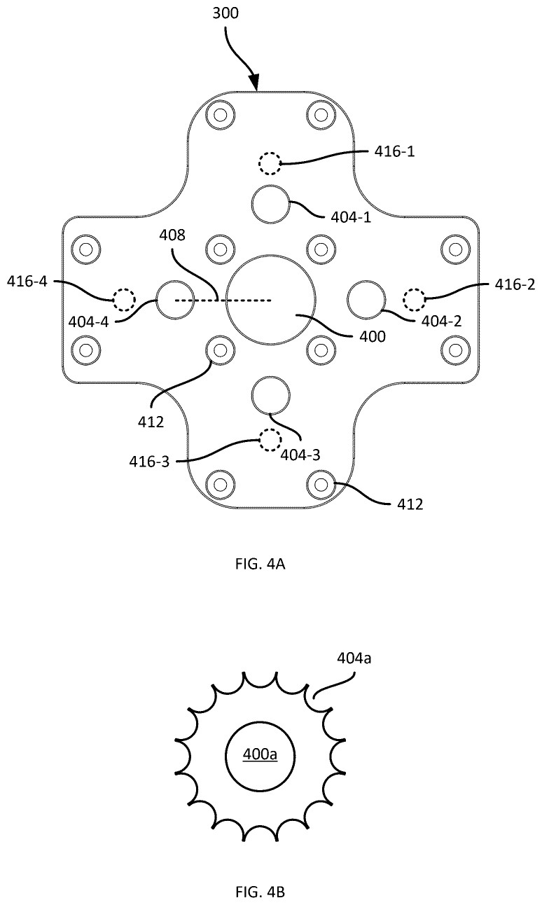

FIG. 4A shows a bottom view of the receiving plate 300 in isolation. The receiving plate 300 includes a center aperture 400, which may extend through the entirety of the plate 300, or which may extend only partially into the receiving plate 300. The depth of the aperture 400 is sufficient to accommodate a complementary component of a docking accessory, discussed below. The receiving plate 300 also includes a plurality of auxiliary apertures 404-1, 404-2, 404-3, and 404-4 (collectively referred to as auxiliary apertures 404, and generically referred to as an auxiliary aperture 404). The auxiliary apertures 404 are disposed around the center aperture 404, e.g., at equal radii 408 from a center of the center aperture 400. The receiving plate 300 can include different numbers of auxiliary apertures 404 in other examples. For example, the receiving plate 300 can include eight or more auxiliary apertures 404 in some examples. The number of auxiliary apertures 404 can define the number of orientations relative to the cart 132 at which the robot 128 can dock, in some embodiments. The auxiliary apertures 404 have smaller diameters than the center aperture 400 in this example, but in other implementations the center aperture 400 can have the same diameter, or a smaller diameter, than the auxiliary apertures 404. The receiving plate 300 can also include one or more openings 412, e.g., to receive bolts or other fasteners as mentioned above, to affix the receiving plate 300 to the cart 132.

In some examples, the receiving plate 300 can include an indicator that can be sensed by the docking accessory or another component of the robot 128. For example, the receiving plate 300 can include indicators 416-1, 416-2, 416-3, and 416-4 corresponding to the positions of the auxiliary apertures 404. The indicators 416 can include magnets embedded in or affixed to the receiving plate 300, in some examples. In other examples, the indicators 416 can include radiofrequency (RF) tags embedded in or affixed to the receiving plate 300, or visual indicators (e.g., barcodes or the like).

FIG. 4B illustrates another receiving plate 300a, including a center aperture 400a and a sawtooth-shaped perimeter that defines a plurality of auxiliary apertures 404a at equal radii from the center of the center aperture 400a. The example in FIG. 4B includes sixteen auxiliary apertures 404a, but a variety of other numbers of auxiliary apertures 404a can also be implemented. As will be apparent from FIG. 4B, the auxiliary apertures 404a need not be enclosed bores into the receiving plate 300, but can instead be partially open channels.

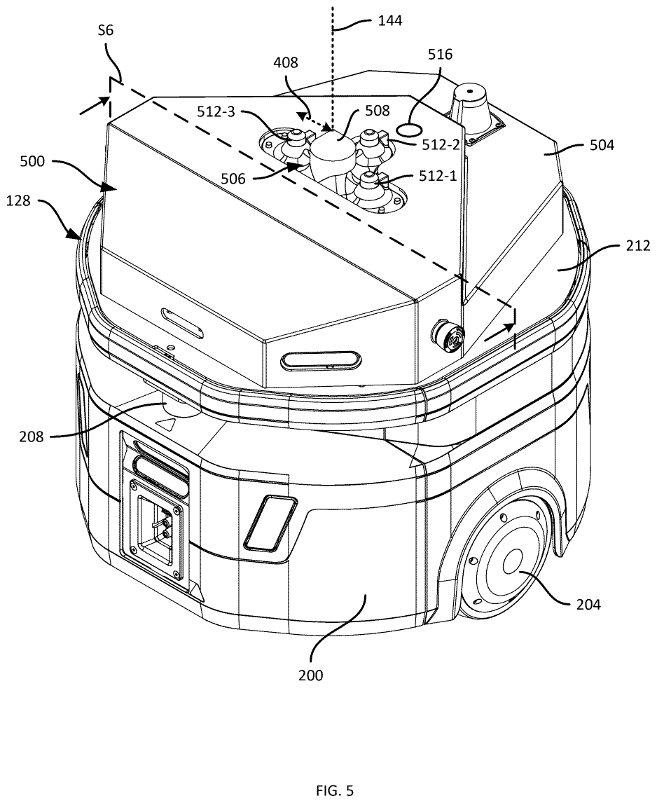

Turning to FIG. 5, a docking accessory 500 is shown mounted to the chassis 200 of the robot 128. The docking accessory 500 includes a base 504 configured to engage with the mounting surface 212 of the robot 128, as discussed above in connection with FIG. 2A, e.g., by way of bolts or other suitable fasteners extending through apertures defined in an underside of the base 504 into the openings 214 of the mounting surface 212. Various other mechanisms for fastening the docking accessory 500 to the chassis 200 can also be employed, such as snap-fit features on the mounting surface 212 and complementary latching features on the base 504. In other examples, the docking accessory 500 can be non-removably affixed to the chassis 200, e.g., as an integral component of the chassis 200. The base 504 can include one or more interfaces complementary with one or more of the interface assemblies 216, e.g., to supply power to components of the docking accessory 500, and/or to collect data from such components and control such components.

The docking accessory 500 also includes a coupling device 506 that is controllable, e.g., by the processor 220 via one or both of the interfaces 216 as mentioned above. The coupling device 506 can be supported on or in the base 504. Control of the coupling device 506 by the processor 220 includes placing the coupling device 506 in one of three states. In a retracted, or disengaged, state, the coupling device 506 does not mechanically engage with the receiving plate 300, and therefore permits translation and rotation (e.g., free movement) of the chassis 200 relative to the cart 312. In an intermediate state, the coupling device 506 is configured to permit rotation of the chassis 200 relative to the receiving plate 300, e.g., about the axis 144, and to constrain translation of the chassis 200 relative to the receiving plate 300. In an engaged, or docked, state, the coupling device 506 is configured to constrain translational motion and rotational motion between the chassis 200 and the receiving plate 300. The processor 220 is configured to select between the above states and transmit control signals to the coupling device 506 via a suitable one of the interfaces 216 to operate the coupling device 506 accordingly, as will be discussed further below.

In the example illustrated in FIG. 5, the coupling device 506 includes a first pin 508, also referred to as a center pin, configured to extend from the base 504 (e.g., substantially upwards, e.g., from a top surface of the base 504, away from the floor or other surface on which the robot 128 travels) into the center aperture 400 of the receiving plate 300. The first pin 508, as seen in FIG. 5, is substantially coaxial with the axis 144, such that the locomotive assembly 204 can rotate the chassis 200 about the first pin 508.

The coupling device 506 also includes at least one additional pin, also referred to herein as an auxiliary pin 512. In this example, the coupling device 506 includes three auxiliary pins 512-1, 512-2, and 512-3. In other examples, the coupling device 506 can include only one auxiliary pin 512, two auxiliary pins 512, or additional auxiliary pins 512 beyond the three shown. Each auxiliary pin 512 is configured to extend from the base 504 (e.g., upwards, as with the first pin 508) into one of the auxiliary apertures 404 of the receiving plate 300. Each auxiliary pin 512 can be accommodated in any of the auxiliary apertures 404, and which auxiliary aperture 404 receives which auxiliary pin 512 is dependent on the orientation of the coupling device 506 (and in this example, dependent therefore on the orientation of the chassis 200).

The auxiliary pins 512-1 and 512-3 are located on opposing (e.g., lateral) sides of the first pin 508 in this example, and the auxiliary pin 512-2 is located on a further (e.g., rearward) side perpendicular to the positions of the auxiliary pins 512-1 and 512-3. Each auxiliary pin 512 is located at an equal distance from the first pin 508, e.g., equal to the radius 408 shown in FIGS. 4 and 5. The coupling device 506 also includes at least one actuator configured to extend and retract the first pin 508 and the auxiliary pins 512 to and from the base 504, to engage and disengage with the receiving plate 300 in each of the above-mentioned states.

As will be shown below, the first pin 508 is configured to extend into the center aperture 400 in the intermediate state and the docked state (but not in the undocked state), while the auxiliary pin(s) 512 are configured to extend into respective auxiliary apertures 404 only in the docked state. In the intermediate state, the auxiliary pins 512 are retracted from the auxiliary apertures 404, and do not engage with the receiving plate 300. The docking accessory 500 and chassis 200 are therefore permitted to rotate relative to the receiving plate 300 in the intermediate state, while being restricted from translating relative to the receiving plate 300. In the docked state, because both the first pin 508 and at least one auxiliary pin 512 are engaged with the receiving plate 300, both rotation and translation between the chassis 200 and the receiving plate 300 are substantially prevented.

The docking accessory 500 can also include one or more sensors, such as a sensor 516, configured to detect the indicators 416 of the receiving plate 300 and thereby enable the processor 220 to determine an orientation of the docking accessory 500 relative to the receiving plate 300. The sensor 516 can include a camera, RF reader, Hall effect sensor, or the like, selected depending on the nature of the indicators 416. The sensor 516 can detect, for example, when the auxiliary pins 512 are aligned with the auxiliary apertures 404, and when the indicators 416 are distinguishable from one another, the sensor 516 can detect which auxiliary aperture 404 is aligned, for example, with the pin 512-2.

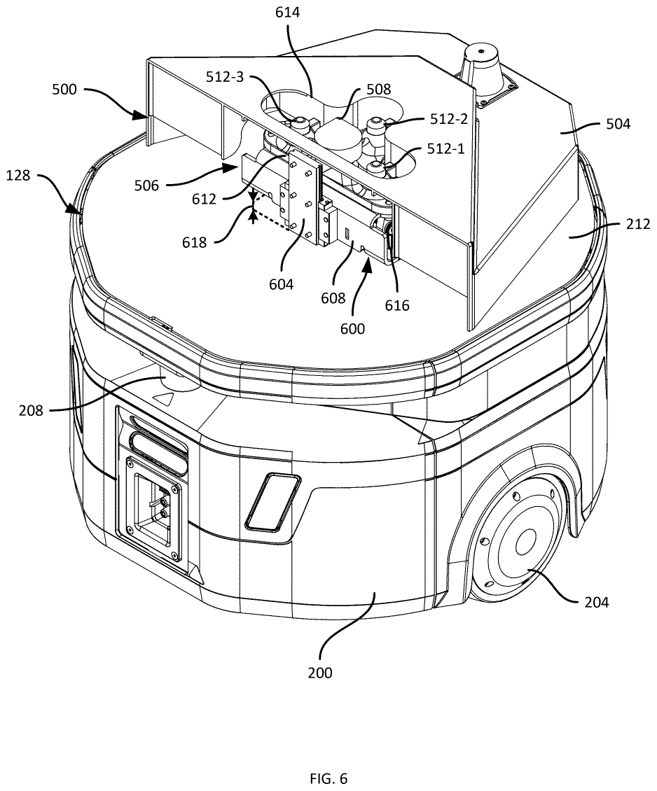

Turning to FIG. 6, the robot 128 and the docking accessory 500 are illustrated, with the base 504 of the docking accessory 500 shown in cross section, according to the sectioning plate S6 illustrated in FIG. 5. Certain additional components of the coupling device 506 are therefore visible in FIG. 6. The coupling device 506 includes a carriage 600 that is movably coupled to the base 504 of the docking accessory 500 (or, in some examples, to the mounting surface 212). In the illustrated example, the coupling device 506 includes a rail 604, extending away (e.g., substantially vertically) from the mounting surface 212.

The rail supports the carriage 600, which in this example includes a mounting plate 608 (e.g., substantially parallel with the rail 604) movably coupled to the rail 604, and a support plate 612 (e.g., substantially perpendicular to the rail 604) that supports the pins 508 and 512. The support plate 612 may also be referred to as an index plate, as the orientation of the plate 612 relative to the receiving plate 300 (e.g., set by controlling the orientation of the chassis 200 with the locomotive assembly 204) serves to index the relative orientation of the robot 128 and the cart 132 to one of a set of predetermined orientations when docked. The base 504 of the docking accessory 500 includes, in this example, an opening 614 allowing the pins 508 and 512 to extend into and out of the base 504.

The coupling device 506 also includes an actuator 616, e.g., a linear solenoid actuator or the like, controllable to move the carriage 600 up and down the rail 604, thus controlling the height of the pins 508 and 512. In the example shown in FIG. 6, the carriage 600 is in a retracted position corresponding to undocked state, with the carriage 600 at a height 618, e.g., as measured from the mounting surface 212 to the mounting plate 608. The actuator 616, in this example, controls the height of all of the pins 508 and 512 simultaneously, as the pins 508 and 512 are all mounted on a common support (that is, the support plate 612). In other examples, the pin 508 can be movable independently from the pins 512, and the coupling device 506 can include more than one actuator, e.g., with a first actuator to move the first pin 508, and a second actuator to move the auxiliary pins 512.

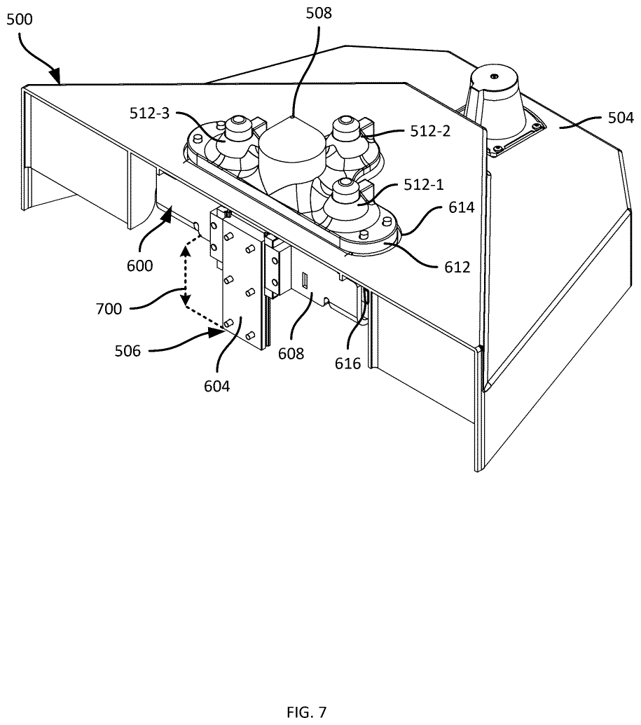

FIG. 7 illustrates the docking accessory 500, in cross section, with the carriage 600 in an extended position relative to the retracted position shown in FIG. 6. The extended position of FIG. 7 corresponds to the docked state, while the retracted position shown in FIG. 6 corresponds to the undocked state. In the docked state, the carriage 600 is at a second height 700 (e.g., measured from the mounting surface 212 to the mounting plate 608, as with the height 618 shown in FIG. 6). As seen in FIG. 7, the pins 508 and 512 extend from the opening 620 in the base 504, to engage with the apertures 400 and 404.

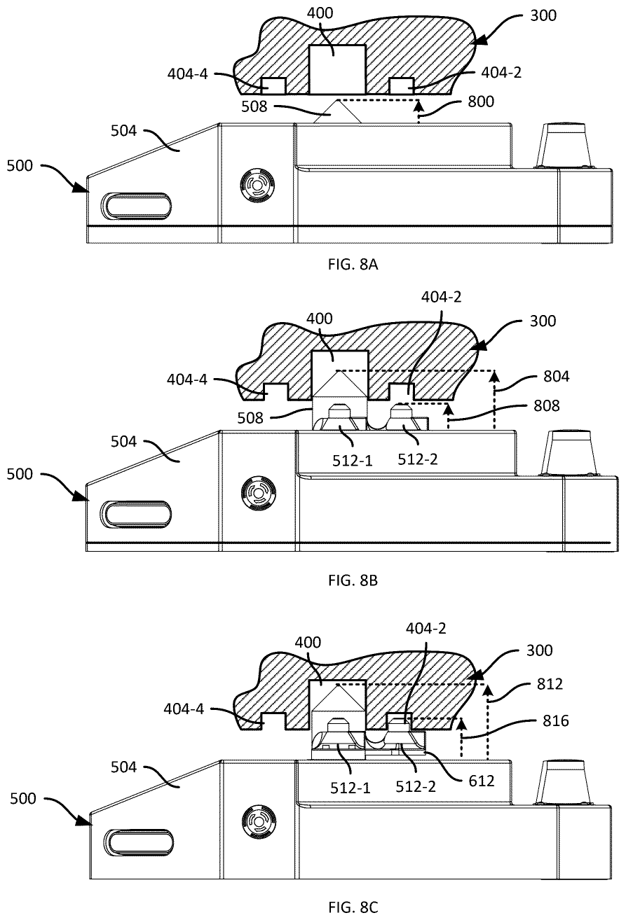

FIG. 8A, FIG. 8B, and FIG. 8C illustrate the docking accessory 500 from the side, in each of the undocked (FIG. 8A), intermediate (FIG. 8B), and docked (FIG. 8C) states. FIGS. 8A-8C also illustrate a partial cross section of the receiving plate 300, to show the position of the aperture 400, as well as the apertures 404-4 and 404-2 (or the apertures 404-1 and 404-3, dependent on the orientation of the robot 128 relative to the receiving plate 300).

In the undocked position shown in FIG. 8A, the pin 508 is at a height 800 below the level of the receiving plate 300, such that the pin 508 does not contact any portion of the receiving plate 300. The pins 512 are retracted within the base 504. In the intermediate position shown in FIG. 8B, the pin 508 is at a height 804 that extends into the center aperture 400. The pins 512-1 and 512-2 (and 512-3, not visible in FIG. 8B) extend from the base 504 to a height 808. The height 808 may be substantially equal to the height 800, and the pins 512 therefore do not engage with the receiving plate 300 in the intermediate position. As will be apparent, when the pin 508 extends into the aperture 400 but the pins 512 do not engage with the receiving plate 300, the docking accessory 500 is constrained from translating relative to the receiving plate 300, but is free to rotate relative to the receiving plate 300.

In the docked position shown in FIG. 8C, the carriage 600 is raised sufficiently for the index plate 612 to extend from the base 504 in this example. The pin 508 is at a height 812, extending further into the aperture 400. The pins 512 are at a height 816, sufficient to extend the pins 512 into corresponding apertures 404. As will be apparent, when the pins 508 and 512 extend into corresponding apertures of the receiving plate 300, the docking accessory 500 is constrained from both rotating and translating relative to the receiving plate 300. As will also be apparent from FIGS. 8A-8C, the pin 508 has a greater height from the index plate 612 than the pins 512, which permits the index plate 612 to be moved as a whole to select which pins engage with the receiving plate 300.

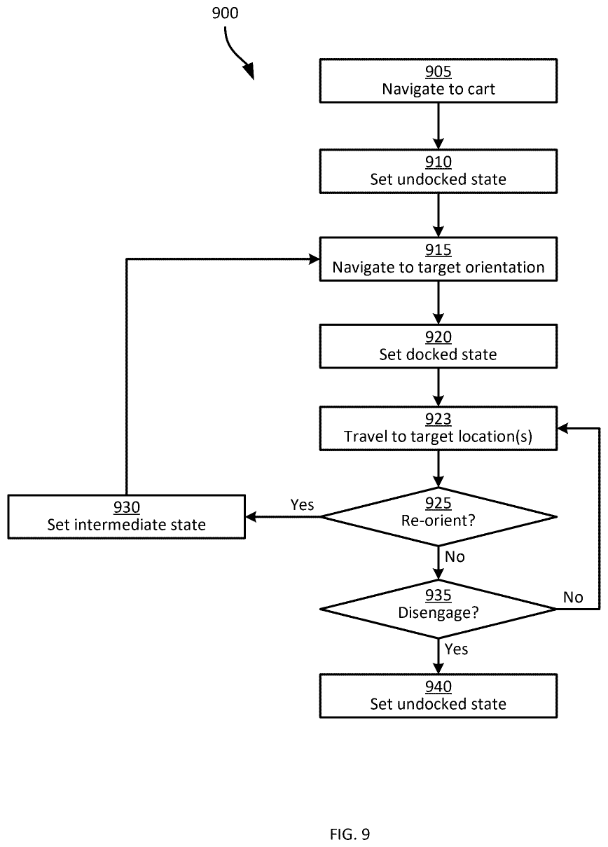

Turning to FIG. 9, a method 900 of engaging with a target object such as the cart 132 is illustrated. The method 900 is described below in conjunction with its performance by the processor 220 of the robot 128, e.g., via execution of the application 226 by the processor 220, and/or by equivalent dedicated hardware elements as noted earlier.

At block 905, the robot 128 is configured to navigate to a target object, such as the cart 132. Block 905 may be initiated, for example, in response to receipt of an instruction at the robot 128 from the server 140 to travel to a certain location (e.g., defined in the coordinate system 134) and dock with a cart 132 at that location. The navigational operations implemented by the robot 128, e.g., using data captured by the sensors 208, to travel to the relevant location, are beyond the scope of this discussion. A wide variety of mechanisms for performing those operations will occur to those skilled in the art. The robot 128 is configured, via block 905, to position itself adjacent to the target cart 132 to prepare for positioning underneath the cart 132 and docking with the cart 132.

At block 910, the processor 220 is configured to set the coupling device 506 to the undocked state, to permit the robot 128 to travel underneath the cart 132 without colliding with the receiving plate 300. In other words, the processor 220 can control the coupling device 506 to lower the pins 508 and 512 as shown in FIG. 8A.

At block 915, the processor 220 can control the locomotive assembly 204, e.g., with input from the sensors 208, to navigate to a target orientation relative to the cart 132. The performance of block 915 can include, for example, traveling from a position adjacent to the cart 132 to a position underneath the cart 132. The performance of block 915 can also include rotating the chassis 200 about the axis 144 to a target orientation. For example, the processor 220 can be configured to select between predetermined target orientations based on a planned direction of travel once the robot 128 is docked with the cart 132. In some examples, the receiving plate 300 may include a plurality of sets of apertures, e.g., at different positions along a length of the cart 132. At block 915, in such examples, the robot 128 can navigate to a selected one of those sets of apertures.

When the robot 128 has positioned itself underneath the cart 132 at the target position, the processor 220 is configured to select between the intermediate state, the docked state, and the undocked state under various conditions, and to control the coupling device 506 according to the selected state. The processor 220 can alternate between the intermediate and docked states more than once in some examples throughout the performance of the method 900, e.g., to re-orient the robot 128 relative to the cart 132 without disengaging from the cart 132. In some examples, the processor 220 can set the coupling device 506 to the intermediate state during the performance of block 915. For example, the robot 128 can travel to a selected position under the cart 132, e.g., aligning the first pin 508 with the center aperture 400. The processor 220 can then set the coupling device 506 to the intermediate state to constrain translation of the chassis 200 relative to the cart 132, before rotating the chassis 200 to a target orientation.

At block 920, upon reaching the target orientation, which may be confirmed by detection of an indicator 416 by the sensor 516, the processor 220 can be configured to select the docked state, controlling the coupling device 506 to constrain both rotational and translation of the chassis 200 relative to the cart 132. In other words, the processor 220 can be configured to raise the carriage 600 to engage the pins 508 and 512 with the apertures 400 and 404, as shown in FIG. 8C.

At block 923, the robot 128 is configured to travel to one or more target locations, e.g., received from the server 140. The processor 220 can perform block 923 by controlling the locomotive assembly 204 to travel along one or more paths generated based on a map of the facility 100 stored in the memory 224. Travel along the above paths can also be executed based on sensor data from the sensor(s) 208, and/or the paths may be modified according to such sensor data, e.g., to avoid unmapped obstacles.

At block 925, the processor 220 can be configured to determine whether to re-orient the robot 128 relative to the cart 132, e.g., based on navigational requirements to fulfill a cart-transport task assigned to the robot 128. For example, the decision to re-orient the robot 128 relative to the cart 132 can be based on a selected direction of travel of the robot 128 and nearby obstacles (e.g., other carts 132) that necessitate moving the cart 132 orthogonally rather than longitudinally.

When the determination at block 925 is affirmative, the processor 220 can proceed to block 930, selecting the intermediate state and thus permitting rotation of the chassis 200 relative to the cart 132, while constraining translation of the chassis 200 relative to the cart 132. The processor 220 can perform block 930 by setting the carriage 600 to the height shown in FIG. 8B, to withdraw the auxiliary pins 512 from the apertures 404, while keeping the pin 508 in the aperture 400. Switching from the docked state to the intermediate state permits the robot 128 to rotate about the axis 144 relative to the cart 132, without entirely disengaging with the cart 132. The intermediate state can therefore reduce the number of docking operations involved in manipulating the cart 132. The robot 128 can then return to block 915, e.g., to navigate to a different orientation relative to the cart 132.

When the determination at block 925 is negative, the processor 220 can maintain the docked state, and determine at block 935 whether to disengage from the cart 132 or other target object (e.g., if an assigned transport task corresponding to the cart 132 has been completed at block 923). When the determination at block 935 is negative, the processor 220 can return to block 923. When the determination at block 935 is affirmative, the processor 220 can set the coupling device 506 to the undocked, or disengaged, state at block 940, following which the robot 128 can move away from the cart 132.

In the embodiments discussed above, the docking accessory 500 is fixed to the chassis 200, such that the orientation of the coupling device 506 is fixed relative to the orientation of the chassis 200. In these embodiments, to re-orient the chassis 200 relative to the cart 132 without fully undocking, the robot 128 can retract the pins 512 from the receiving plate 300, and then rotate the chassis 200 via control of the locomotive assembly 204. In other examples, the robot 128 can be configured to maintain a fixed engagement with the cart 132, and to rotate the coupling device itself to permit re-orientation of the cart 132 relative to the chassis 200.

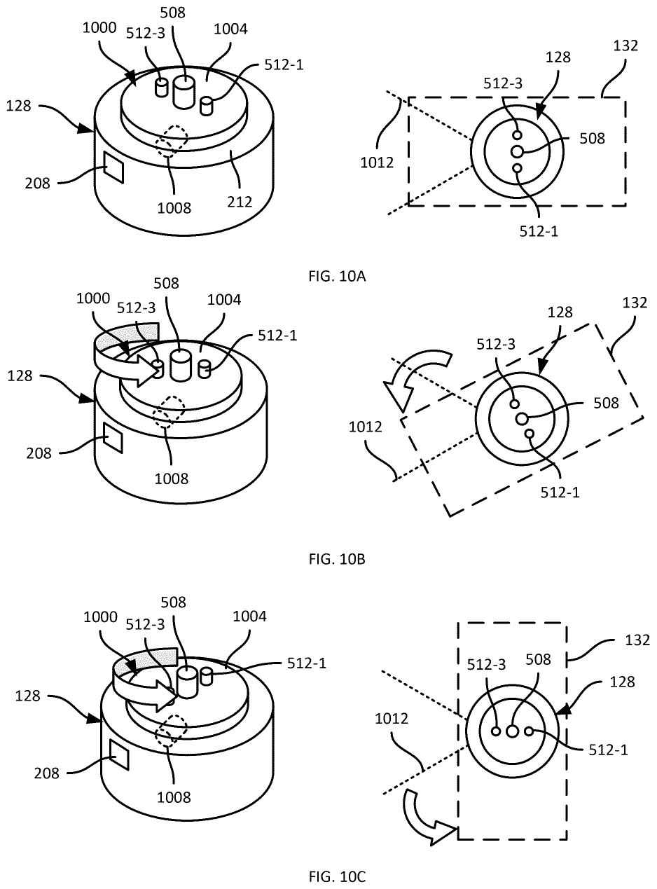

Turning to FIGS. 10A, 10B, and 10C, in such embodiments, the robot 128 can include a docking accessory 1000, e.g., coupled to the mounting surface 212. The docking accessory 1000 can include rotatable index platform or plate 1004, e.g., driven by an actuator 1008 within the docking accessory 1000 or the chassis 200. The processor 220 can control the orientation of the index plate 1004 relative to the chassis 200, and thus the orientation of the cart 132 when the cart 132 is docked. For example, the processor 220 can track the current orientation of the index plate 1004, and can drive the actuator 1008 to rotate the index plate 1004 (and thus the cart 132) to a new orientation. In this example, in the undocked state the pins 508 and 512 are withdrawn from the receiving plate 300 as described in connection with the embodiments of FIGS. 1-8C above. In the intermediate state, the pins 508 and 512 are engaged, and the actuator 1008 is controlled to rotate the index plate 1004 relative to the chassis 200. Thus, in the intermediate state, translation between the cart 132 and the chassis 200 is constrained, while rotation between the cart 132 and the chassis 200 is permitted (and actively effected by the processor 220). In the docked state, the actuator 1008 can be locked, or another locking mechanism can be engaged, to also constrain rotation between the cart 132 and the chassis 200.

In addition to a perspective view of the robot 128, each of FIGS. 10A-10C illustrates an overhead view of the robot 128 and the cart 132, as well as a field of view 1012 of the sensor(s) 208, indicating a direction of travel of the robot 128. FIG. 10B shows a reorientation of the index plate 1004, e.g., following a performance of block 930 of the method 900, which re-orients the cart 132 while the direction of travel of the robot 128 remains unchanged. FIG. 10C illustrates a further re-orientation, resulting in the chassis 200 and the cart 132 being oriented relative to one another to permit orthogonal travel (FIG. 10C) instead of longitudinal travel (FIG. 10C). In some examples, the above transitions can be made during forward motion by the robot 128, e.g., to re-orient the cart 132 in transit to avoid obstacles, orient the cart 132 for parking between other carts 132, or the like.

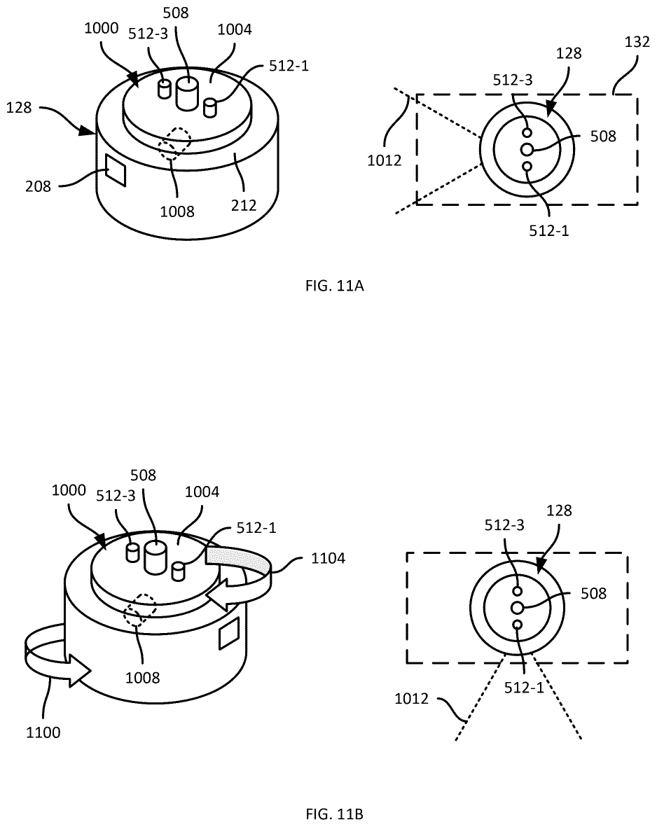

In further examples, the docking accessory 1000 can be controlled to re-orient the robot 128 relative to the cart 132 while maintaining the orientation of the cart 132 itself, e.g., relative to its surroundings. For example, FIG. 11A shows the robot 128 in a first orientation relative to the cart 132. In FIG. 11B, the chassis 200 has rotated (e.g., via control of the locomotive assembly 204) in a first direction 1100, and the index plate 1004 has rotated in an opposite direction 1104. As a result, the orientation of the cart 132 remains substantially static, and the orientation of the robot 128 changes relative to the cart 132, such that forward travel by the robot 128 will lead to orthogonal travel by the cart 132, rather than longitudinal travel (as in FIG. 11A).

The docking accessories described above thus allow re-orientation of the robot 128 relative to the cart 132, without fully disengaging from the cart 132. These docking accessories therefore permit the robot 128 to travel with the cart 132 facing orthogonally, longitudinally, or in an oblique orientation (e.g., as shown in FIG. 10B). The systems and methods of the present disclosure may enable lower cost implementation of multi-directional cart movement (e.g., by avoiding the need for sensor suites 208 facing multiple directions to enable multiple “forward” directions of travel). The features discussed herein may also permit the robot 128 to accommodate higher payloads, and/or park carts 132 closer to other obstacles, and/or maneuver through narrow corridors or passages (e.g., gaps, etc.) that necessitate dynamic re-orientation of the cart 132 relative to the robot 128.

With specific regard to fulfillment and material movement applications, the systems and methods of the present disclosure enable the AMR to navigate narrow aisles or pathways with the cart, while traversing in orthogonal or non-orthogonal directions, enable for higher density of cart parking, reduce the amount of torque required to perform turn-in-place or radial turns by the AMR, and increase payload capacity of the AMR and cart by mitigating the need for the robot 128 to turn in place while under load (which can involve caster “flip” as noted earlier).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises ...a”, “has ...a”, “includes ...a”, “contains ... a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A mobile robot, comprising:
a chassis;
a locomotive assembly secured to the chassis;
a coupling device disposed on the chassis, the coupling device comprising a base with first and second pins configured to extend from the base and engage with a target object; and
a processor configured to:
control the locomotive assembly to position the coupling device relative to the target object;
select between (i) an intermediate state, and (ii) a docked state;
in response to selecting the intermediate state, control the coupling device to permit rotation of the chassis relative to the target object, and constrain translation of the chassis relative to the target object; and
in response to selecting the docked state, control the coupling device to constrain rotation and translation of the chassis relative to the target object.

2. The mobile robot of claim 1, further comprising a docking accessory base affixed to the chassis and supporting the coupling device; wherein the first pin is configured to extend from the base into a center aperture of the target object in the intermediate state and the docked state; and
wherein the second pin is configured to (i) extend from the base into one of a plurality of auxiliary apertures of the target object in the docked state, and (ii) retract from the auxiliary aperture in the intermediate state.

3. The mobile robot of claim 2, wherein the coupling device comprises:
an actuator configured to extend and retract each of the first pin and the second pin.

4. The mobile robot of claim 2, wherein the coupling device comprises:
a carriage supporting the first pin and the second pin, the carriage movably coupled to the base; and
an actuator configured to:
(i) in an undocked state, set the carriage at a first height to retract the first and second pins from the center aperture and the auxiliary aperture;
(ii) in the intermediate state, set the carriage at a second height to extend the first pin into the center aperture; and
(iii) in the docked state, set the carriage at a third height to extend the first pin into the center aperture and the second pin into the auxiliary aperture.

5. The mobile robot of claim 4, wherein the first pin has a first height greater than a second height of the second pin.

6. The mobile robot of claim 2, wherein the coupling device further comprises:
a third pin configured to (i) extend from the base into another one of the auxiliary apertures of the target object in the docked state, and (ii) retract from the other auxiliary aperture in the intermediate state.

7. The mobile robot of claim 6, wherein the second pin and the third pin are disposed on opposite sides of the first pin.

8. The mobile robot of claim 2, wherein the coupling device further comprises:
a sensor configured to detect when the second pin is aligned with the one of the auxiliary apertures.

9. The mobile robot of claim 1, wherein the coupling device comprises:
a base affixed to the chassis;
a platform rotatably disposed on the base;
a plurality of pins configured, in the intermediate state and the docked state, to extend from the platform into corresponding apertures of the target object; and
an actuator configured to rotate the platform relative to the base in the intermediate state, and to constrain rotation of the platform relative to the base in the docked state.

10. An interface system for an autonomous mobile robot, comprising:
an index plate configured to be mounted on a mobile robot, the index plate having a center pin and one or more index pins extending from a top surface thereof;
a receiving plate configured to be mounted to a support structure, the receiving plate having a center aperture configured to receive the center pin, and a plurality of auxiliary apertures holes configured to receive the one or more index pins;
wherein the index plate is positionable in:
(i) a first state in which the center pin is received by the center aperture, and the one or more index pins are received by respective ones of the auxiliary apertures, thereby constraining rotational movement between the index plate and the receiving plate; and
(ii) a second position in which the center pin is received by the center aperture and the one or more index pins are not received by the auxiliary apertures, thereby allowing rotational movement between the index plate and the receiving plate.

11. A docking accessory for a mobile robot, the docking accessory comprising:
a coupling device configured for support by a chassis of the mobile robot, the coupling device configured to engage with a target object and movable between (i) a docked state to constrain rotation and translation of the chassis relative to the target object, and (ii) an intermediate state to permit rotation of the chassis relative to the target object, and constrain translation of the chassis relative to the target object; and
a communications interface to communicatively connect the coupling device with a processor and receive control instructions therefrom.

12. The docking accessory of claim 11, further comprising:
a base affixed to the chassis and supporting the coupling device;
wherein the coupling device comprises:
a first pin configured to extend from the base into a center aperture of the target object in the intermediate state and the docked state;
a second pin configured to (i) extend from the base into one of a plurality of auxiliary apertures of the target object in the docked state, and (ii) retract from the auxiliary aperture in the intermediate state.

13. The docking accessory of claim 12, wherein the coupling device comprises:
an actuator configured to extend and retract each of the first pin and the second pin.

14. The docking accessory of claim 12, wherein the coupling device comprises:
a carriage supporting the first pin and the second pin, the carriage movably coupled to the base; and
an actuator configured to:
(i) in an undocked state, set the carriage at a first height to retract the first and second pins from the center aperture and the auxiliary aperture;
(ii) in the intermediate state, set the carriage at a second height to extend the first pin into the center aperture; and
(iii) in the docked state, set the carriage at a third height to extend the first pin into the center aperture and the second pin into the auxiliary aperture.

15. The docking accessory of claim 14, wherein the first pin has a first height greater than a second height of the second pin.

16. The docking accessory of claim 12, wherein the coupling device further comprises: a third pin configured to (i) extend from the base into another one of the auxiliary apertures of the target object in the docked state, and (ii) retract from the other auxiliary aperture in the intermediate state.

17. The docking accessory of claim 16, wherein the second pin and the third pin are disposed on opposite sides of the first pin.

18. The docking accessory of claim 12, wherein the coupling device further comprises:
a sensor configured to detect when the second pin is aligned with the one of the auxiliary apertures.

19. The docking accessory of claim 11, wherein the coupling device comprises:
a base affixed to the chassis;
a platform rotatably disposed on the base;
a plurality of pins configured, in the intermediate state and the docked state, to extend from the platform into corresponding apertures of the target object; and
an actuator configured to rotate the platform relative to the base in the intermediate state, and to constrain rotation of the platform relative to the base in the docked state.
